(19) United States
(12) Patent Application Publication
(10) Pub. No.: US 2016/0041307 A1
(43) Pub. Date: Feb. 11, 2016

(54) METHOD OF FORMING AN ANTI-GLARE COATING ON A SUBSTRATE

(71) Applicant: PPG INDUSTRIES OHIO, INC., Cleveland, OH (US)

(72) Inventor: Songwei Lu, Wexford, PA (US)

(21) Appl. No.: 14/455,109

(22) Filed: Aug. 8, 2014

(51) Int. Cl. G02B 1/11; C09D 183/08; B05D 5/06; B05D 1/02; B05D 3/02

(52) U.S. Cl. CPC G02B 1/11; B05D 1/02; B05D 3/0218; B05D 5/06; C09D 183/08

(57) ABSTRACT

A method of forming an anti-glare coating on a substrate is provided. The method comprises: (a) heating the substrate to a temperature of at least 100° F. (37.8° C.) to form a hot substrate; (b) applying a curable film-forming sol-gel composition on at least one surface of the hot substrate, to form a coated substrate with a sol-gel network layer having a surface roughness; and (c) subjecting the coated substrate to conditions for a time sufficient to effect cure of the sol-gel layer and form an anti-glare, coated article. The sol-gel network layer is essentially free of inorganic oxide particles and comprises:

(i) a tetraalkoxysilane;

(ii) an epoxy functional trialkoxysilane;

(iii) a metal-containing catalyst; and

(iv) a solvent component. Coated articles prepared by the method above and demonstrating anti-glare properties are also provided.

### FIELD OF THE INVENTION

The present invention relates to coated articles and methods of forming anti-glare coatings on a substrate.

### BACKGROUND OF THE INVENTION

Transparent screens such as display screens and touch screens appear more and more frequently on interactive electronic devices. Reducing glare of the screens is desired to maximize visibility of the displays in different lighting environments. There are various known methods of reducing the glare of transparent substrate surfaces. An exemplary method involves depositing a light interference coating stack on the substrate that reduces reflection by exploiting the optical interference within adjacent thin films. Such films usually have a thickness of about one-quarter or one-half the nominal wavelength of visible light, depending on the relative indices of refraction of the coatings and substrate. Another method includes forming a light scattering means at the surface of the substrate, such as by mechanically altering the outermost surface of the substrate or through use of a diffuser coating on the glass substrate.

Interference coatings reduce glare without reducing resolution. However, they are relatively expensive to deposit, requiring the use of vacuum deposition techniques such as sputtering and precise manufacturing conditions, or very precise alkoxide solution dip coating techniques, with subsequent drying and firing steps. Strict processing parameters must be observed to obtain the desired results.

Fillers are widely used in the coatings industry to affect gloss and they are known to provide glare resistance to substrates in many cases. Fillers control gloss by affecting the surface roughness of an applied coating.

Etching the outer surface of the substrate or otherwise chemically or mechanically modifying the outer surface of a coating deposited on the substrate has been attempted in an effort to reduce glare by diffusion of light. There are numerous drawbacks to such modification techniques. Etching by chemical means involves handling and storage of generally highly corrosive compounds (e.g. hydrofluoric acid). Such compounds create processing and disposal problems in view of increasingly stringent environmental laws. Etching by non-chemical means, such as by sandblasting, necessitates additional and costly processing operations.

It would be desirable to provide an alternative method of forming an anti-glare coating on a substrate while avoiding the drawbacks of the prior art.

### SUMMARY OF THE INVENTION

A method of forming an anti-glare coating on a substrate is provided. The method comprises: (a) heating the substrate to a temperature of at least 100° F. (37.8° C.) to form a hot substrate; (b) applying a curable film-forming sol-gel composition on at least one surface of the hot substrate, to form a coated substrate with a sol-gel network layer having a surface roughness; and (c) subjecting the coated substrate to conditions for a time sufficient to effect cure of the sol-gel layer and form an anti-glare, coated article. The sol-gel network layer is essentially free of inorganic oxide particles and comprises;

(i) a tetraalkoxysilane;

(ii) an epoxy functional trialkoxysilane;

(iii) a metal-containing catalyst; and

(iv) a solvent component; and

Coated articles demonstrating anti-glare properties and prepared by the method above are also provided.

### DETAILED DESCRIPTION OF THE INVENTION

Other than in any operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in this specification and the appended claims, the articles “a,” “an,” and “the” include plural referents unless expressly and unequivocally limited to one referent.

The various embodiments and examples of the present invention as presented herein are each understood to be non-limiting with respect to the scope of the invention.

As used in the following description and claims, the following terms have the meanings indicated below:

By “polymer” is meant a polymer including homopolymers and copolymers, and oligomers. By “composite material” is meant a combination of two or more differing materials.

The term “curable”, as used for example in connection with a curable composition, means that the indicated composition is polymerizable or cross linkable through functional groups, e.g., by means that include, but are not limited to, thermal (including ambient cure), catalytic, electron beam, chemical free-radical initiation, and/or photoinitiation such as by exposure to ultraviolet light or other actinic radiation.

The term “cure”, “cured” or similar terms, as used in connection with a cured or curable composition, e.g., a “cured composition” of some specific description, means that at least a portion of any polymerizable and/or crosslinkable components that form the curable composition is polymerized and/or crosslinked. Additionally, curing of a composition refers to subjecting said composition to curing conditions such as those listed above, leading to the reaction of the reactive functional groups of the composition. The term “at least partially cured” means subjecting the composition to curing conditions, wherein reaction of at least a portion of the reactive groups of the composition occurs. The composition can also be subjected to curing conditions such that a substantially complete cure is attained and wherein further curing results in no significant further improvement in physical properties, such as hardness.

The term “reactive” refers to a functional group capable of undergoing a chemical reaction with itself and/or other functional groups spontaneously or upon the application of heat or in the presence of a catalyst or by any other means known to those skilled in the art.

The terms “on”, “appended to”, “affixed to”, “bonded to”, “adhered to”, or terms of like import means that the designated item, e.g., a coating, film or layer, is either directly connected to the object surface, or indirectly connected to the object surface, e.g., through one or more other coatings, films or layers.

The term “optical quality”, as used for example in connection with polymeric materials, e,g., a “resin of optical quality” or “organic polymeric material of optical quality” means that the indicated material, e.g., a polymeric material, resin, or resin composition, is or forms a substrate, layer, film or coating that can be used as an optical article, such a glazing, or in combination with an optical article.

The term “rigid”, as used for example in connection with an optical substrate, means that the specified item is self-supporting.

The term “optical substrate” means that the specified substrate exhibits a light transmission value (transmits incident light) of at least 4 percent, such as at least 50 percent, or at least 70 percent, or at least 85 percent; and exhibits a haze value of less than 5 percent, e.g., less than percent or less than 0.5 percent, when the haze value is measured at 550 nanometers by, for example, a Haze Gard Plus Instrument. Optical substrates include, but are not limited to, optical articles such as lenses, optical layers, e.g., optical resin layers, optical films and optical coatings, and optical substrates having a light influencing property.

The term “transparent”, as used for example in connection with a substrate, film, material and/or coating, means that the indicated substrate, coating, film and/or material has the property of transmitting light without appreciable scattering so that objects lying beyond are entirely visible.

Substrates suitable for use in the method of the present invention and preparation of the coated articles of the present invention can include metals, glass, or any of the plastic optical substrates known in the art, provided the material can withstand temperatures of at least 100° F. without deformation. Suitable metal substrates include highly polished stainless steel substrates. Suitable glass substrates include soda-lime-silica glass, such as soda-lime-silica slide glass sold from Fisher, or aluminosilicate glass such as Gorilla® glass from Corning Incorporated, or Dragontrail® glass from Asahi Glass Co., Ltd. Suitable examples of plastic substrates include polyol(allyl carbonate) monomers, e.g., allyl diglycol carbonates such as diethylene glycol bis(allyl carbonate), which monomer is sold under the trademark CR-39 by PPG Industries, Inc.; polyurea-polyurethane (polyurea urethane) polymers, which are prepared, for example, by the reaction of a polyurethane prepolymer and a diamine curing agent, a composition for one such polymer being sold under the trademark TRIVEX® by PPG Industries, Inc.; polyol(meth)acryloyl terminated carbonate monomer; diethylene glycol dimethacrylate monomers; ethoxylated phenol methacrylate monomers; diisopropenyl benzene monomers; ethoxylated trimethylol propane triacrylate monomers; ethylene glycol bismethacrylate monomers; polyethylene glycol) bismethacrylate monomers; urethane acrylate monomers; poly(ethoxylated Bisphenol A dimethacrylate); poly(vinyl acetate); poly(vinyl alcohol); poly(vinyl chloride); poly(vinylidene chloride); polyethylene; polypropylene; polyurethanes; polythiourethanes; thermoplastic polycarbonates, such as the carbonate-linked resin derived from Bisphenol A and phosgene, one such material being sold under the trademark LEXAN; polyesters, such as the material sold under the trademark MYLAR; poly(ethylene terephthalate); poly(vinyl butyral; poly(methyl methacrylate), such as the material sod under the trademark PLEXIGLAS, and polymers prepared by reacting polyfunctional isocyanates with polythiols or polyepisulfide monomers, either homopolymerized or co- and/or terpolymerized with polythiols, polyisocyanates, polyisothiocyanates and optionally ethylenically unsaturated monomers or halogenated aromatic-containing vinyl monomers. Also suitable are copolymers of such monomers and blends of the described polymers and copolymers with other polymers, e.g., to form interpenetrating network products.

In the first step of the method of the present invention, the substrate is heated to a temperature of at least 100° F. (37.8° C.) to form a hot substrate. Depending on the nature of the substrate, higher temperatures may be used. For example, when the substrate is glass, the substrate may be heated to a temperature of 100 to 450° F. (37.8 to 232.2° C.), such as 230 to 400° F. (110 to 204.4° C.), or 250 to 350° F. (121.1 to 176.7° C.)

In step (b) of the method of the present invention, a curable film-forming sol-gel composition is applied to at least one surface of the hot substrate, to form a coated substrate with a sol-gel network layer having a surface roughness. Sol-gels are dynamic systems wherein a solution (“sol”) gradually evolves into a gel-like two-phase system containing both a liquid phase and solid phase, whose morphologies range from discrete particles to continuous polymer networks within the continuous liquid phase.

The sol-gel network layer that is formed on the hot substrate comprises a hybrid “inorganic-organic” network; i.e., the network layer comprises both inorganic and organic structural groups on the molecular level. This allows for some variability in design with respect to mechanical properties of the sol-gel layer, such as flexibility.

The curable film-forming composition used to form the sol-gel layer comprises (i) a tetraalkoxysilane. Because of the sol-gel nature of the composition, the alkoxysilanes are hydrolyzed and they are partially condensed prior to curing of the layer. The hydrolyzed tetraalkoxysilane in the sol-gel layer typically comprises tetramethoxysilane and/or tetraethoxysilane.

The curable film-forming solid composition further comprises (ii) an epoxy functional trialkoxysilane, such as 3-glycidoxypropyl trimethoxysilane, and 3-(Glycidyloxypropyl)triethoxysilane. The epoxy functional trialkoxysilane may be partially hydrolyzed with water.

The curable film-forming sol-gel composition additionally comprises (iii) a metal-containing catalyst, such as an aluminum-containing catalyst. Examples include aluminum hydroxychloride or aluminum acetylacetonate. Colloidal aluminum hydroxychloride catalysts are available from Summit Reheis as SUMALCHLOR 50 and from NALCO as NALCO 8676.

The curable film-forming sol-gel composition also comprises (iv) a solvent component. The solvent component may include water and one or more polar organic solvents, including ethers such as cyclic ethers, glycol ethers, alcohols having 1 to 6 carbon atoms, such as methanol, ethanol, n-propanol, isopropanol, n-butanol, and the like. Glycol ethers such as propylene glycol methyl ether, propylene glycol methyl ether acetate, dipropylene glycol monomethyl ether, and/or diethylene glycol monobutyl ether are used most often.

The curable film-forming sol-gel composition used in the method of the present invention forms a sol-gel network layer on the substrate surface that is essentially free of inorganic oxide particles such as silica or aluminum oxide particles. As used throughout this specification, including the claims, by “essentially free” is meant that if a compound is present in a composition, it is present incidentally in an amount less than 0.1 percent by weight, often less than 0.05 percent by weight or less than 0.01 percent by weight, usually less than trace amounts.

The curable film-forming sol-gel compositions can include a variety of optional ingredients and/or additives that are somewhat dependent on the particular application of the final coated article. For example, the composition may exhibit a light influencing property. Other optional ingredients include rheology control agents, surfactants, initiators, catalysts, cure-inhibiting agents, reducing agents, acids, bases, preservatives, free radical donors, free radical scavengers and thermal stabilizers, which adjuvant materials are known to those skilled in the art.

The curable film-forming sol-gel compositions may include a colorant, although typically the compositions are colorless and transparent. They are also usually optically clear, having a light transmission of at least 70% and demonstrating a haze value less than 65% depending on gloss level.

The curable film-forming sol-gel composition typically has a solids content of 0.1 to 35 percent by weight, often 0.5 to 15 percent by weight, more often 1 to 8 percent by weight, based on the total weight of the curable film-forming composition.

Suitable sol-gel compositions that may be used in step (b) of the method of the present invention include HI-CARD 1080 and HI--CARD 10805, both commercially available from PPG Industries, Inc. The sol-gel compositions may also be further diluted with appropriate solvents as described above.

The sol-gel composition may be applied to the hot substrate by one or more of a number of methods such as spraying, dipping (immersion), spin coating, or flow coating onto a surface thereof. Spraying is used most often, such as ultrasonic spray application, precision spray application, and air atomized spray application. The sol-gel composition may be more often kept at ambient temperature immediately prior to application. Upon contact with the hot substrate, solvents are immediately driven from the sol-gel composition and a coated substrate is formed with a sol-gel network layer having a surface roughness. The applied porous sol-gel layer typically has a dry film thickness of less than 10 microns, often less than 5 microns, or less than 3 microns.

After application of the sol-gel layer, the coated substrate is then subjected to conditions for a time sufficient to effect cure of the sol--gel layer and form an anti-glare, coated article. For example, the coated substrate may be heated to a temperature of at least 120° C. for at least 0.5 hours, to promote the continued polymerization of the composition. In particular examples, the coated substrate may be heated to a temperature of 120° C. for at least 3 hours, or the coated substrate may be heated to a temperature of at least 150° C. for at least 0.5 hours.

The sol-gel composition forms a matte finish (low gloss), anti-glare coating on the substrate. Coated articles of the present invention formed by the method described above typically demonstrate a 60 gloss value of 15 to 120 gloss units, as measured by a micro-TRI-gloss meter from BYK-Gardner GmbH. Coated articles of the present invention demonstrate reduced glare without reducing resolution of a display viewed through the article. This is particularly advantageous when the coated article is an optical article such as a screen for an electronic device such as a phone, monitor, tablet, or the like.

The anti-glare performance of the curable coating composition is achieved by the formation of a sol-gel network with a surface roughness on the substrate, which occurs upon impingement of the sol-gel composition on the hot substrate. The rapid evaporation of solvents from the sol-gel composition minimizes flow of the composition on the hot substrate surface, and thus prevents the formation of a smooth, high-gloss coating layer. It is noted that if the sol-gel composition is applied to the substrate without prior heating of the substrate surface to at least 100° F., an anti-glare coating does not form, but rather a smooth, high gloss coating results.

This method of forming anti-glare coatings is in contrast to methods of the prior art, which use anti-glare coatings containing inorganic oxide particles. The particles serve to decrease the gloss of the coating layer by increasing the surface roughness thereof. As noted above, the sol-gel network layer formed in the method of the present invention is essentially free of such particles.

The coated articles of the present invention may further comprise at least one additional coating composition applied to the coated article after step (c). For example, an anti-fouling coating or sealant layer may be superimposed on at least one surface of the sol-gel layer.

Suitable sealant layers may comprise perfluorosilane such as DC2700 from Dow Corning, or Optool DSX from Daikin.

Optical articles of the present invention include a display element such as screens, including touch screens, on devices including cell phones, tablets, GPS, voting machines, POS (Point-Of-Sale), or computer screens; display sheets in a picture frame; windows, or an active or passive liquid crystal cell element or device, and the like.

The following examples are intended to illustrate various embodiments of the invention, and should not be construed as limiting the invention in any way.

### EXAMPLES

Hi-gard® HC 1080S coating solution is commercially available from PPG Industrials, Inc., Hi-gard HC 1080S is diluted with DOWANOL™ PMA (Propylene glycol methyl ether acetate) and/or DOWANOL™ PIM (Propylene glycol methyl ether), commercially available from The Dow Chemical Company, as listed in the Table below. The mixture solution is then stirred for 30 min at ambient temperature.

TABLE 1
Hi-Gard ® AG coating Solution fomulations (in grams)

| | | | | | Solid |
|---|---|---|---|---|---|
| | | Dowanol | Dowanol | | content |
| | HG-1080S | PM | PMA | Total | (%) |
| Hi-Gard ® AG20 | 20 | 0 | 80 | 100 | 6.6 |
| Coating Solution | | | | | |
| Hi-Gard ® AG60 | 15 | 5 | 80 | 100 | 4.95 |
| Coating Solution | | | | | |
| Hi-Gard ® AG70 | 10 | 10 | 80 | 100 | 3.3 |
| Coating Solution | | | | | |
| Hi-Gard ® AG100 | 5 | 40 | 55 | 100 | 1.65 |
| Coating Solution | | | | | |

The glass substrates, 2″×3″×1 mm microscope slide glass purchased from Fisher Scientific were heated in a 220° C. oven for 6 minutes on a metal sample holder before moving to a spray booth for spray AG coatings. The Hi-Gard® AG coating solutions were then sprayed on the glass substrates with a temperature ranging from 130 to 150° C. using a SPRAYMATION and a Binks 95 automatic HVLP spray gun with spray parameters listed as below.

TABLE 2
spray parameters using a spraymation and a Binks 95 spray gun

| | Example | | | | | |
|---|---|---|---|---|---|---|
| | A | B | C | D | E | |
| | Targeting gloss value | | | | | |
| | GU <20 | GU60 ± 10 | GU70 ± 10 | GU80 ± 10 | GU100 ± 10 | Unit |
| HI-Gard ® AG Coating Solution | AG20 | AG60 | AG70 | AG 70 | AG100 | |
| Air pressure | 50 | 50 | 50 | 50 | 50 | PSI |
| Distance between glass and | 5 | 5 | 5 | 5 | 5 | Inch |
| nozzle | | | | | | |
| Flow rate | 47.5 | 42.4 | 43 | 37.8 | 34.8 | g/min |
| Total pass | 2 | 1 | 1 | 1 | 1 | Pass |
| Time of glass in 220° C. oven | 6 | 6 | 6 | 6 | 6 | min |
| Glass Temperature | 150 | 150 | 150 | 150 | 150 | ° C. |
| Nozzle traveling speed | 800 | 700 | 800 | 700 | 800 | mm/min |

The coated glass samples were then cured at 150° C. for 35 min.

Optical properties of the coated glass samples were measured, including gloss value at 60° angle, transmittance at 550 nm, color L*, a*, and b*, and haze. The gloss value was measured using a Micro-Tri-gloss meter from BYK-Gardner GmbH. Transmittance color and haze were measured using X-Rite 17 Color Spectrophotometer from X-Rite.

| | | Transmittance | Haze | | | |
|---|---|---|---|---|---|---|
| Example | Gloss (GU) | (%) | (%) | L* | a* | b* |
| E-1 | 90 | 90.573 | 6.53 | 96.22 | −0.05 | 0.04 |
| E-2 | 102.5 | 91.119 | 3.69 | 96.45 | −0.07 | 0.06 |
| E-3 | 105 | 91.038 | 3.98 | 96.41 | −0.06 | 0.09 |
| E-4 | 96.5 | 91.025 | 3.75 | 96.4 | −0.09 | 0.1 |
| E-5 | 96 | 91.131 | 3.9 | 96.46 | −0.08 | 0.02 |
| E-6 | 102.5 | 90.858 | 3.67 | 96.35 | −0.05 | 0.1 |
| E-7 | 103.5 | 90.866 | 4.72 | 96.34 | −0.05 | 0.14 |
| E-8 | 99 | 90.973 | 3.19 | 96.38 | −0.06 | 0.09 |
| E-9 | 104 | 91.384 | 2.87 | 96.55 | −0.1 | 0.04 |
| E-10 | 104.5 | 91.271 | 2.56 | 96.5 | −0.09 | 0.06 |
| D-1 | 73.5 | 89.645 | 6.59 | 95.82 | 0 | 0.14 |
| D-2 | 69.5 | 89.866 | 5.42 | 95.92 | −0.01 | 0.16 |
| D-3 | 73 | 90.153 | 6.31 | 96.03 | −0.03 | 0.13 |
| D-4 | 73 | 90.001 | 5.72 | 95.96 | −0.02 | 0.13 |
| D-5 | 71 | 90.04 | 5.57 | 95.99 | −0.04 | 0.14 |
| D-6 | 61.5 | 89.917 | 5.48 | 95.94 | −0.03 | 0.14 |
| D-7 | 69.5 | 90.911 | 4.63 | 96.34 | −0.05 | 0.11 |
| D-8 | 93.5 | 90.923 | 4.52 | 96.36 | −0.04 | 0.09 |
| D-9 | 98.5 | 90.573 | 4.09 | 96.21 | −0.02 | 0.11 |
| D-10 | 86.5 | 90.951 | 4.48 | 96.37 | −0.02 | 0.09 |
| C-1 | 72 | 89.597 | 8.13 | 95.81 | 0.01 | 0.18 |
| C-2 | 71 | 89.481 | 6.56 | 95.76 | −0.02 | 0.13 |
| C-3 | 69 | 89.833 | 9.33 | 95.92 | 0 | 0.03 |
| C-4 | 70 | 89.41 | 8.4 | 95.73 | 0 | 0.15 |
| C-5 | 67 | 89.522 | 7.97 | 95.79 | 0 | 0.11 |
| C-6 | 70 | 89.828 | 8.25 | 95.91 | −0.01 | 0.06 |
| C-7 | 72.5 | 89.955 | 6.38 | 95.96 | −0.03 | 0.1 |
| C-8 | 61 | 88.491 | 13.41 | 95.43 | −0.08 | −0.52 |
| C-9 | 69 | 89.245 | 9.75 | 95.67 | 0.03 | 0.15 |
| C-10 | 67 | 89.612 | 8.5 | 95.83 | 0 | 0.1 |
| B-1 | 63 | 89.014 | 7.42 | 95.58 | −0.02 | 0.13 |
| B-2 | 62 | 88.795 | 8.86 | 95.49 | −0.01 | 0.12 |
| B-3 | 51.5 | 88.674 | 8.37 | 95.45 | −0.02 | 0.12 |
| B-4 | 55 | 88.402 | 10.6 | 95.32 | 0.01 | 0.07 |
| B-5 | 61.5 | 88.901 | 7.77 | 95.54 | −0.02 | 0.14 |
| B-6 | 51.5 | 88.415 | 9.49 | 95.33 | −0.01 | 0.12 |
| B-7 | 57 | 88.66 | 9.01 | 95.44 | 0.01 | 0.11 |
| B-8 | 56 | 88.726 | 7.98 | 95.46 | −0.02 | 0.12 |
| B-9 | 60.5 | 89.4 | 7.02 | 95.74 | −0.04 | 0.12 |
| A-1 | 13.5 | 86.485 | 61.04 | 94.61 | 0.21 | −1.76 |
| A-2 | 14.5 | 85.51 | 55.44 | 94.19 | 0.22 | −1.52 |
| A-3 | 16 | 85.13 | 51.24 | 94.03 | 0.25 | −1.31 |
| A-4 | 14 | 86.125 | 57.04 | 94.46 | 0.22 | −1.61 |
| A-5 | 15 | 85.493 | 55.2 | 94.18 | 0.22 | −1.5 |
| A-6 | 13.5 | 86.333 | 57.52 | 94.55 | 0.23 | −1.6 |
| A-7 | 13.5 | 86.584 | 61.47 | 94.65 | 0.21 | −1.78 |
| A-8 | 19 | 84.505 | 34.85 | 93.72 | 0.12 | −0.79 |
| A-9 | 14 | 86.003 | 56.82 | 94.4 | 0.19 | −1.6 |
| A-10 | 16 | 84.846 | 47.47 | 93.89 | 0.16 | −1.24 |

Whereas particular embodiments of this invention have been described above for purposes of illustration, it will be evident to those skilled in the art that numerous variations of the details of the present invention may be made without departing from the scope of the invention as defined in the appended claims.

What is claimed is:

1. A method of forming an anti-glare coating on a substrate comprising:
(a) heating the substrate to a temperature of at least 100° F. (37.8° C.) to form a hot substrate;
(b) applying a curable film-forming sol-gel composition on at least one surface of the hot substrate, to form a coated substrate with a sol-gel network layer having a surface roughness; wherein the sol-gel network layer is essentially free of inorganic oxide particles and wherein the curable film-forming sol-gel composition comprises:
(i) a tetraalkoxysilane;
(ii) an epoxy functional trialkoxysilane;
(iii) a metal-containing catalyst; and
(iv) a solvent component; and
(c) subjecting the coated substrate to conditions for a time sufficient to effect cure of the sol-gel layer and form an anti-glare, coated article.

2. The method of claim 1 wherein the substrate comprises a plastic, glass, or metal.

3. The method of claim 1, wherein the substrate comprises glass and is heated in step (a) to a temperature of 230 to 450° F. (110 to 232.2° C.).

4. The method of claim 1, wherein, immediately prior to application to the substrate, the curable film-forming composition is kept at ambient temperature.

5. The method of claim 1 wherein the tetraalkoxysilane (i) in the curable film-forming composition comprises tetramethoxysilane and/or tetraethoxysilane.

6. The method of claim 1, wherein the epoxy functional trialkoxysilane (ii) in the curable film-forming composition comprises glycidoxypropyl trimethoxysilane.

7. The method of claim 1 wherein the metal-containing catalyst (iii) in the curable film-forming composition comprises colloidal aluminum hydroxychloride or aluminum acetylacetonate.

8. The method of claim 1 wherein the curable film-forming composition is spray applied to the hot substrate in step (b).

9. The method of claim 1 wherein the coated substrate is heated to a temperature of at least 120° C. for at least 0.5 hour in step (c).

10. The method of claim 1 wherein the coated article formed in step (c) demonstrates a 60° gloss value of 15 gloss units to 120 gloss units.

11. A coated article demonstrating anti-glare properties, wherein the coated article is prepared by a process comprising:
(a) heating the substrate to a temperature of at least 100° F. (37.8° C.) to form a hot substrate;
(b) applying a curable film-forming sol-gel composition on at least one surface of the hot substrate, to form a coated substrate with a sol-gel network layer having a surface roughness; wherein the sol-gel network layer is essentially free of inorganic oxide particles and wherein the curable film-forming sol-gel composition comprises:
(i) a tetraalkoxysilane;
(ii) an epoxy functional trialkoxysilane;
(iii) a metal-containing catalyst; and
(iv) a solvent component; and
(c) subjecting the coated substrate to conditions for a time sufficient to effect cure of the sol-gel layer and form an anti-glare, coated article.

12. The coated article of claim 11, wherein said coated article is an optical article.

13. The coated article of claim 12, wherein said optical article comprises a window, touch screen, cell phone screen, tablet screen, GPS screen, voting machine screen, POS (Point-Of-Sale) screen, computer screen, display sheet in a picture frame, or an active or passive liquid crystal cell element or device.

14. The coated article of claim 11 wherein the substrate comprises glass and is heated in step (a) to a temperature of 230 to 450° F. (110 to 232.2° C.).

15. The coated article of claim 11, wherein, immediately prior to application to the substrate, the curable film-forming composition is kept at ambient temperature.

16. The coated article of claim 11 wherein the tetraalkoxysilane (i) in the curable film-forming composition comprises tetramethoxysilane and/or tetraethoxysilane.

17. The coated article of claim 11 wherein the epoxy functional trialkoxysilane (ii) in the curable film-forming composition comprises glycidoxypropyl trimethoxysilane.

18. The coated article of claim 11 wherein the metal-containing catalyst (iii) in the curable film-forming composition comprises colloidal aluminum hydroxychloride or aluminum acetylacetonate.

19. The coated article of claim 11 wherein the curable film-forming composition is spray applied to the hot substrate in step (b).

20. The coated article of claim 11 wherein the coated article formed in step (c) demonstrates a 60 gloss value of 15 gloss units to 120 gloss units.

21. The coated article of claim 11, wherein at least one additional coating composition is applied to the coated article after step (c).

22. A coated article demonstrating anti-glare properties, wherein the coated article comprises:
(a) a transparent substrate having at least one flat surface;
(b) a cured film-forming sol-gel composition applied to at least a portion of the flat surface of the substrate, wherein the cured film-forming sol-gel composition is deposited from a composition comprising:
(i) a tetraalkoxysilane;
(ii) an epoxy functional trialkoxysilane;
(iii) a metal-containing catalyst; and
(iv) a solvent component;
and wherein the coated article demonstrates a 60 gloss value of 15 to 120 gloss units and a light transmittance of at least 84%.
